(19) United States
(12) Patent Application Publication
(10) Pub. No.: US 2005/0188620 A1
(43) Pub. Date: Sep. 1, 2005

(54) Clip-on high load balance shoe for tilt window

(76) Inventors: Neeman Malek, Lorraine (CA); Sylvain Durand, Lachenaie (CA)

Correspondence Address: ROBERT A SEEMANN, 89 EARL AVE, HAMDEN, CT, 06514, US

(21) Appl. No.: 10/893,675

(22) Filed: Jul. 16, 2004

Related U.S. Application Data
(60) Provisional application No. 60/548,253, filed on Feb. 27, 2004.

(51) Int. Cl. E05D 15/22

(52) U.S. Cl. 49/181

(57) ABSTRACT

A balance shoe mounts on a pair of cross bars in a rigid U-shaped channel by an upward facing slot on the shoe receiving one bar, and a downward facing channel on the shoe containing a resilient hook that hooks over the other bar as the shoe is rotated on the first bar to the bottom of the channel, a spring and pulley system in the channel supported by a cord attached to the window frame supports the sash along the vertical travel length of the sash. The sash is supported by a cam in the shoe that is turned by a pivot arm on the sash that is rotated by the sash as the sash rotates in and out of a window frame. The cam forces brake surfaces against the track to prevent vertical movement of the sash along the window frame when the sash is rotated out of the frame.

This application claims the benefit of U.S. Provisional Application No. 60/548,253 filed Feb. 27, 2004.

### BACKGROUND OF THE INVENTION

1. Field of the Invention

The invention relates to balance shoes for tilt window sashes. More particularly the invention relates to a balance shoe adapted for traveling in a vertical track on a window frame. The shoe clip mounts on a pair of cross braces in a rigid U-shaped channel in which a spring and pulley system supported by a cord attached to the window frame supports the sash along the vertical travel length of the sash. The sash is supported by a cam in the shoe that is turned by a pivot arm on the sash that is rotated by the sash as the sash rotates in and out of a window frame. The cam operates means for engaging the track to prevent vertical movement of the sash along the window frame when the sash is rotated out of the frame.

2. Description of the Prior Art

In U.S. Pat. No. 6,679,000 patented by Uken et al. on Jan. 20, 2004, a balance shoe is mounted in a rigid U-shaped channel containing a spring and pulley system. The shoe mounts on the U-shaped channel by a transverse groove in the shoe on a bar through opposite walls of the U-shaped channel and a pair of pins on opposite sides of the shoe that extend resiliently apart into holes in the opposite walls of the U-shaped channel. Support force between the channel and shoe is vertical, parallel to the length of the channel. Most of the support force between the channel and the shoe is borne by the transverse groove and bar. This can be adequate for operation of the balance system at the average home sash weight.

Since the pins would receive the force in shear, distance between the transverse groove and pins must be kept to a narrow tolerance to avoid shearing off the pins from the weight of the sash. Distance between the pins and the back of the shoe must also be kept to a narrow tolerance to avoid shearing off the pins when installing the shoe by pressing the shoe into the channel.

### SUMMARY OF THE INVENTION

It is one object of the invention to provide a balance shoe for a tilt window sash that prevents vertical movement of the sash along the window frame when the sash is tilted or rotated out of the frame.

It is another object of the invention that the balance shoe mounts in a U-shaped channel that contains spring and pulley means for counterbalancing the window sash.

It is another object that the balance shoe receives counterbalance support force that is transferred from the U-shaped channel to the shoe in compression on two tandem surfaces of the shoe in tandem grooves on the shoe.

It is another object that a first groove on the shoe receives a first transverse bar that extends into opposite walls of the U-shaped channel, and a second groove on the shoe receives a second transverse bar that extends into the opposite walls of the U-shaped channel.

It is another object that a resilient element on the shoe locks the second bar in the second groove.

It is another object that the first groove receives the first bar in a first direction and the second groove receives the second bar in a direction that is opposite to the first direction.

A balance shoe for a window comprising a jamb and a sash adapted for rotating out of the jamb, includes:
a frame, a counterbalance comprising an elastic element having a first end attached to the frame against movement along the frame, and a second end attached to a first movable pulley block connected by a chord to a second pulley block attached to the frame against movement along the frame, for counterbalancing the frame when the cord is attached to a jamb,
a first bar extending transverse to the length mounted on the frame, and a second bar extending transverse to the length mounted on the frame spaced from the first bar,
a housing adapted for moving along the jamb, means on the housing responsive to rotation of the sash on a first axis for engaging the jamb for preventing movement of the housing along the jamb when the sash is rotated out of the jamb when the housing is mounted on the jamb and connected to the sash, a first groove on the shoe shaped for receiving the first bar in a first direction, and a second groove on the shoe, spaced from the first groove and shaped for receiving the second bar in a second direction opposite to the first direction when the housing is mounted on the frame,
a resilient element molded in one piece with the housing, extending across the second groove sufficiently so that the second bar is locked in the second groove by the resilient element when the housing is mounted on the frame with the second bar in the second groove, wherein the first direction is generally parallel to the first axis when the housing is mounted on the jamb and connected to the sash.

Other objects and advantages will become apparent to one reading the ensuing description.

U.S. Provisional Application Ser. No. 60/548,253 filed Feb. 27, 2004 is hereby incorporated herein by reference in its entirety.

### BRIEF DESCRIPTION OF THE DRAWINGS

In order that the invention be more fully comprehended, it will now be described, by way of example, with reference to the accompanying drawings, in which:

FIG. 1 is a perspective view of a balance shoe assembly mounted in a window frame, connected to a window sash.

FIG. 2 is an enlarged perspective view taken from a lower angle of the assembly of FIG. 1.

FIG. 3 is a schematic back view of a balance shoe assembly according to the invention.

FIG. 4 is a front perspective view of a balance shoe of the invention.

FIG. 5 is a back perspective view of the balance shoe of FIG. 4

FIG. 6 is a back view of the balance shoe of FIG. 4

FIG. 7 is a side view of the balance shoe of FIG. 4.

FIG. 8 is a front view of the balance shoe of FIG. 4.

FIG. 9 is a side and front perspective view of the balance shoe of FIG. 4.

FIG. 10 is an opposite side and front perspective view of the balance shoe of FIG. 9.

FIG. 11 is a front view of the balance shoe of FIG. 4 without the cam.

FIG. 12 is a cross section view of the balance shoe of FIG. 11 taken along 12-12.

FIG. 13 is a perspective view of a U-shaped channel and cross pins or bars, according to the invention.

FIG. 14 is a front and side perspective view of the balance shoe of FIG. 4 mounted pivotally on a cross bar in the channel of FIG. 13.

FIG. 15 is a another front and side perspective view of the balance shoe of FIG. 4 mounted pivotally on a cross bar in the channel of FIG. 13.

FIG. 16 is a side view of the of the balance shoe of FIG. 4 mounted pivotally on a cross bar in the channel of FIG. 13.

FIG. 17 is a front and side perspective view with partial cut away, of the balance shoe of FIG. 14 mounted in the channel of FIG. 13, receiving two cross bars, locked over one of the cross bars.

FIG. 18 is a back and side perspective view with partial cut away, of the balance shoe of FIG. 14 receiving two cross bars, locked over one of the cross bars.

FIG. 19 is a side view with partial cut away, of the balance shoe of FIG. 18, front side down receiving two cross bars, locked over one of the cross bars.

FIG. 20 is a front perspective view of another shoe of the invention, shown without the cam.

FIG. 21 is back perspective view of the shoe of FIG. 20.

FIG. 22 is a side view of the shoe of FIG. 20 with the front facing up.

FIG. 23 is a front and side perspective view of the balance shoe of FIG. 20 mounted pivotally on a cross bar in the channel of FIG. 13.

FIG. 24 is a back and side perspective view of the balance shoe of FIG. 20 mounted pivotally on two cross bars in the channel of FIG. 13.

FIG. 25 is a front perspective partial view of another shoe of the invention, shown without the cam.

FIG. 26 is a front partial view of the shoe of FIG. 25.

FIG. 27 is a cross section partial view of the show of FIG. 26 taken along 27-27, mounted on cross bars.

FIG. 28 is a back partial view of the shoe of FIG. 25.

FIG. 29 is a cross section partial view of the shoe of FIG. 27 partially rotated off a cross bar.

FIG. 30 is a schematic perspective view of a step in the installation of the assembly of FIG. 17 in a vertical track adapted for vertical travel of the balance and a window sash.

FIG. 31 is a schematic perspective view of another step in the installation of the assembly of FIG. 17 in the track.

FIG. 32 is a schematic perspective view of another step in the installation of the assembly of FIG. 17 in the track.

FIG. 33 is a schematic perspective view of another step in the installation of the assembly of FIG. 17 in the track.

### DESCRIPTION OF THE PREFERRED EMBODIMENTS

Before explaining the invention in detail, it is to be understood that the invention is not limited in its application to the detail of construction and arrangement of parts illustrated in the drawings since the invention is capable of other embodiments and of being practiced or carried out in various ways. It is also to be understood that the phraseology or terminology employed is for the purpose of description only and not of limitation.

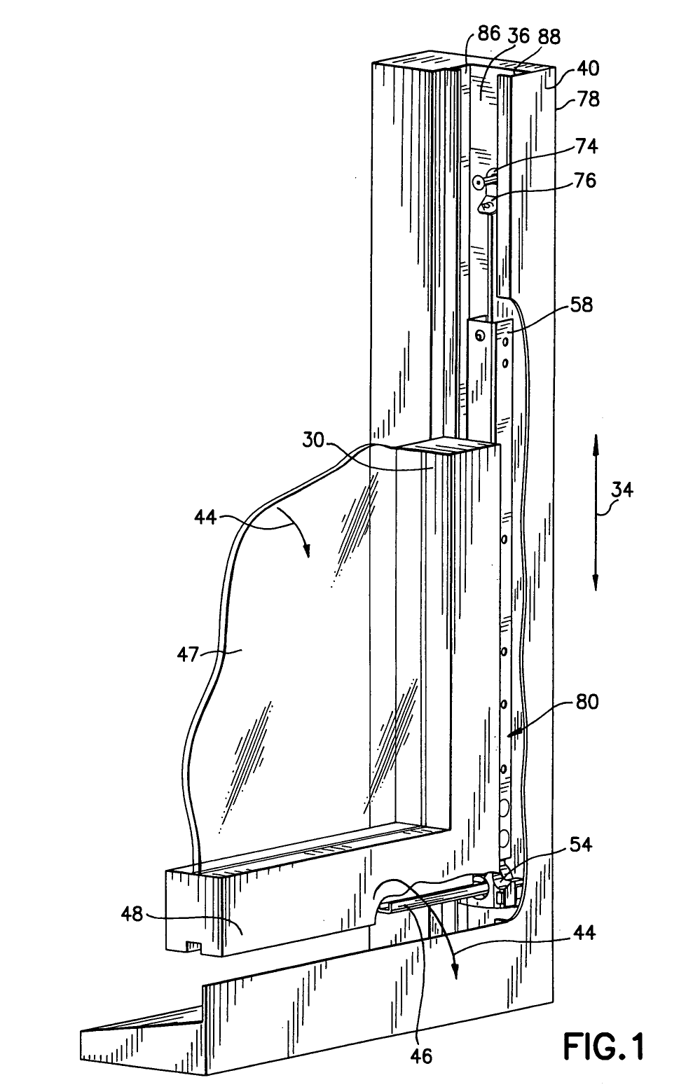

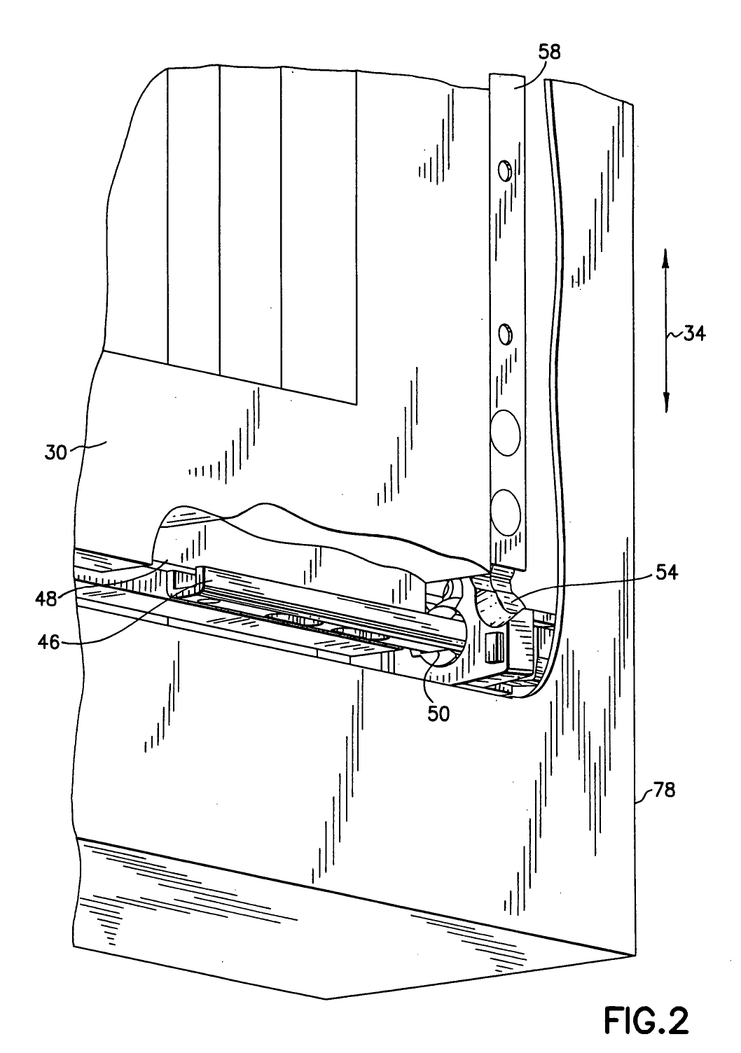

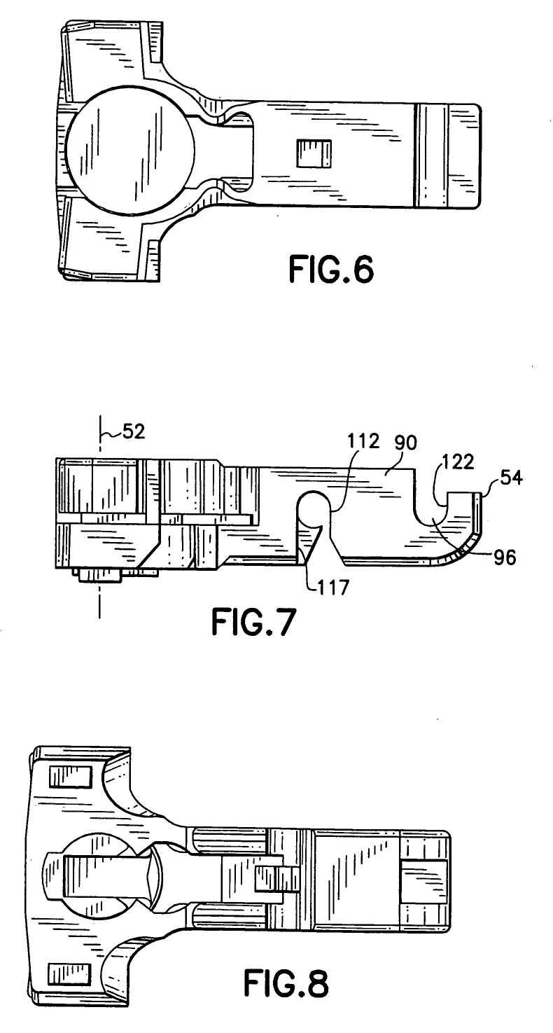

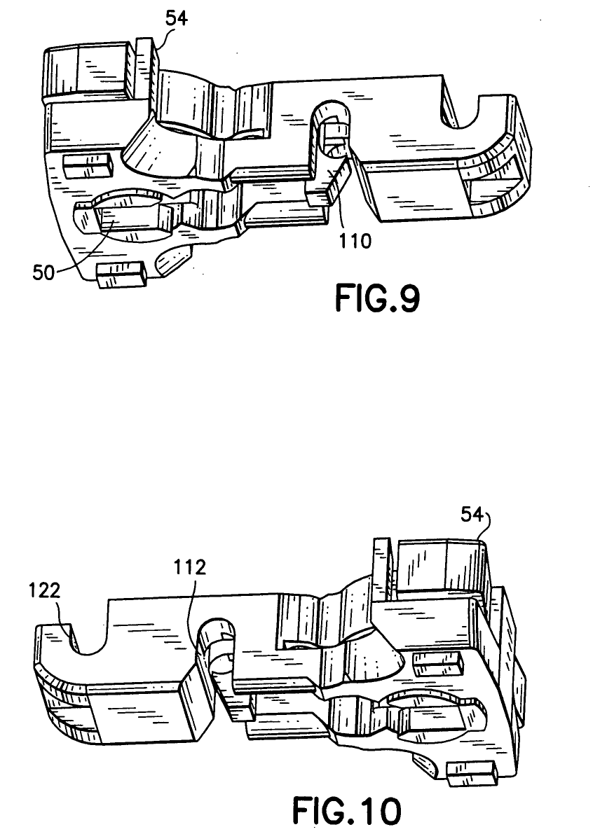

Referring to FIGS. 1-10, sash 30 is adapted to travel vertically 34 on track 36 of window jamb 40. The sash can be raised to any desired height in the jamb and tilted or rotated 44 at pivot bar 46 out of the jamb, say into a room, for cleaning lights 47. Rotating the sash out of the jamb locks the sash against vertical movement in the jamb.

A bearing, not shown, at the top of a sash stile is urged by spring pressure into engagement with the track for keeping the stile parallel to the track until one desires to rotate the window out of the jamb. The bearing is temporarily drawn back into the stile by hand to permit rotation of the sash out of the jamb.

Pivot bar 46 which is fastened to bottom rail 48 of the sash, extends into slot 50 of balance shoe 54 which slides vertically in track 36 as the sash is moved vertically.

Balance shoe 54 is mounted in U-shaped channel 58 which travels vertically with the shoe and the sash.

U-shaped channel 58 hangs from cross bar 60 which hangs from spring 62 which hangs from block and tackle 64 pulleys 66, 68 and cord 70 which hangs from attachment 74 of attachment element 76 to window frame 78.

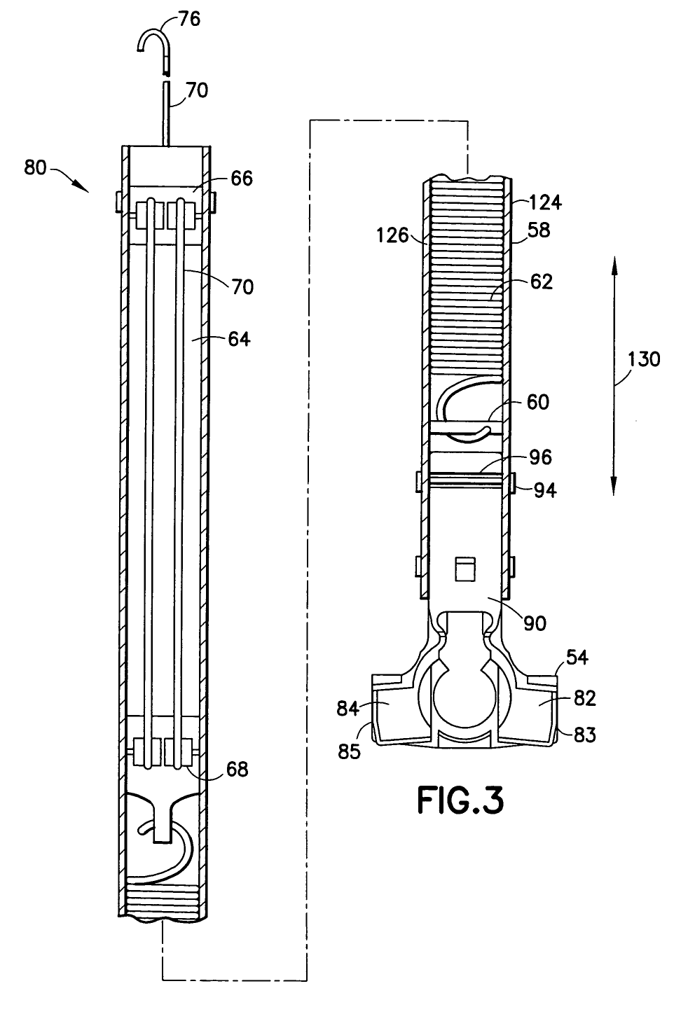

As balance shoe assembly 80 of FIGS. 1 and 3 is also on the opposite side of the sash, about half of the weight of the sash supported by pivot bar 46 and transferred to balance shoe 54 is counterbalanced by the combination of spring and block and tackle hanging from attachment 74.

The shoe remains in track 36, and channel 58 stays vertical, when sash 30 is rotated at pivot bar 46. When the sash is rotated out of the jamb, the pivot bar rotates cam 56 of the shoe on axis 52 so that the cam forces resilient legs 82, 84 radially apart so that brake faces 83, 85 press against sides 86, 88 of the track, braking the shoe against vertical movement in the track preventing vertical movement of bottom rail 48 of the tilted sash.

Housing 90 of shoe 54 is preferably molded in one piece of plastic which is strong enough to support the weight of the sash received by the cam when the cam is in housing 90. The plastic is also resilient enough for spreading of legs 82, 84 without fracture. Such plastics include Nylon and Acetal. Other breaking devices to stop vertical movement of a balance shoe in a track include teeth and pucks slid, displaced or otherwise moved against the track by means for camming rotated by the pivot bar. The brake mechanism of the balance shoe of the invention is not limited to the example shown, but may be chosen from any in the balance shoe brake mechanism art.

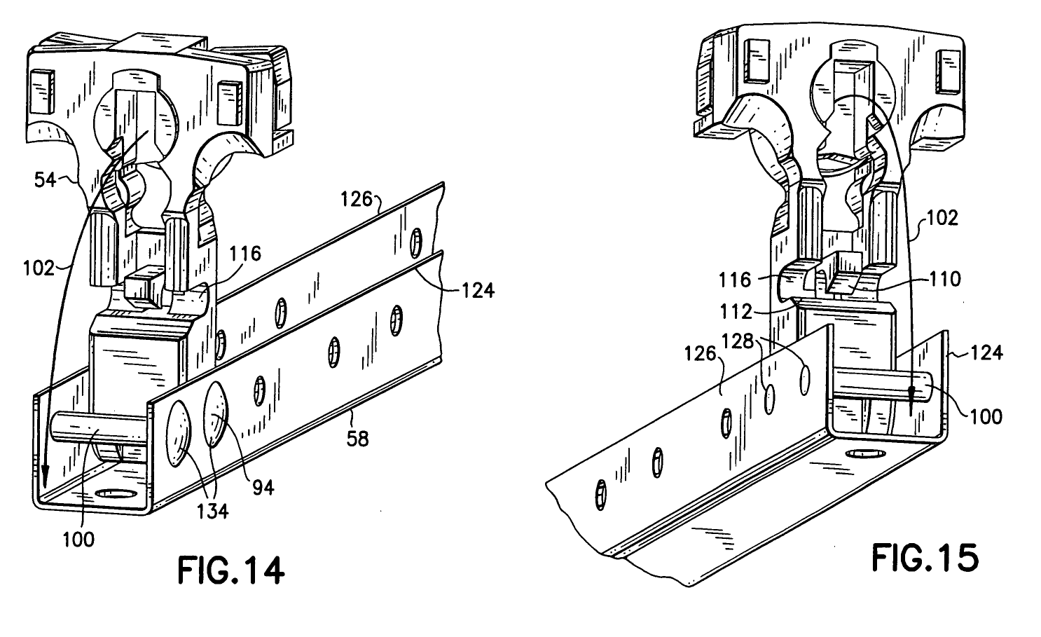

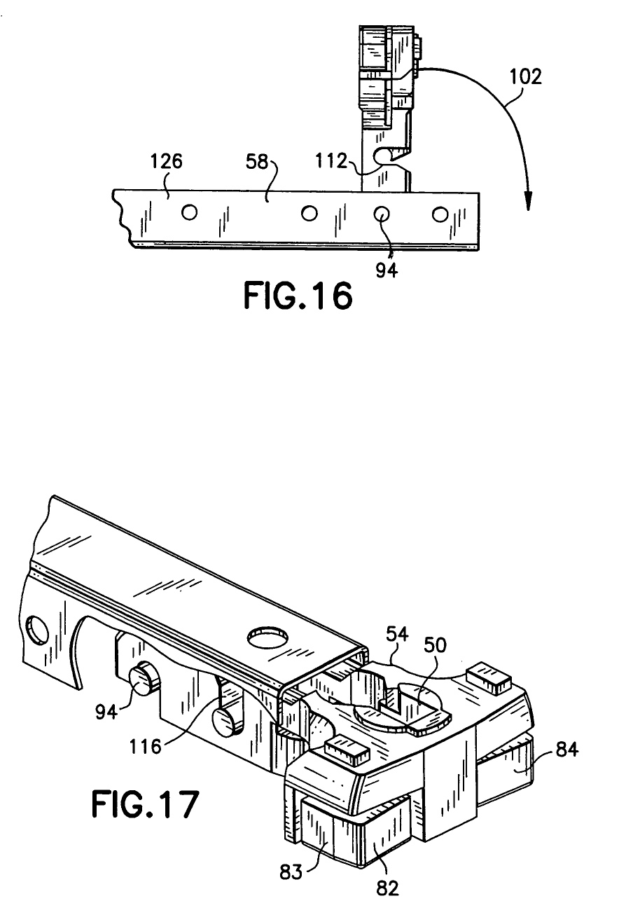

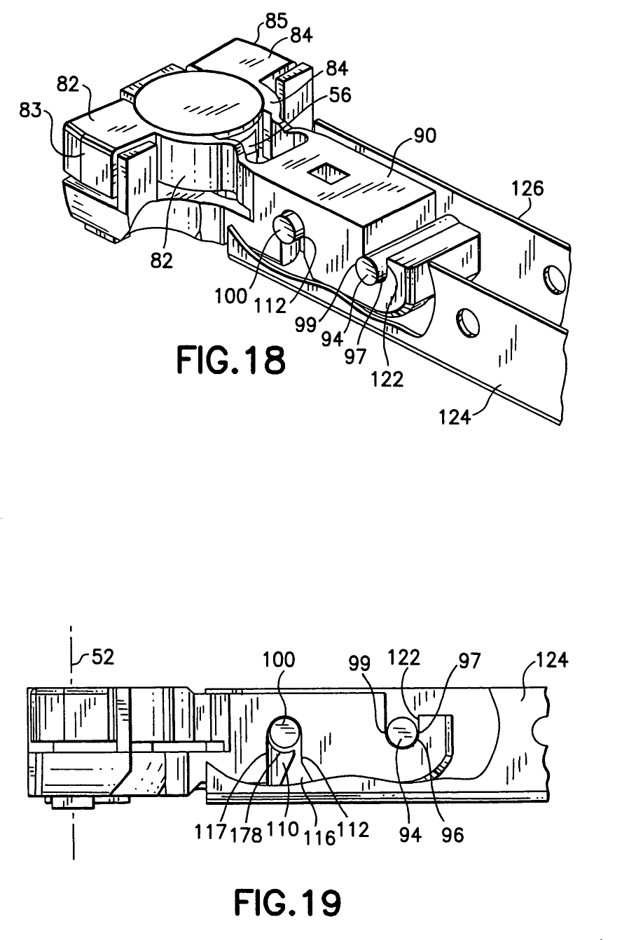

Referring to FIGS. 3 and 13-19, balance shoe 54 is mounted on U-shaped channel 58 by hooking the shoe pivotally under cross bar 94 by groove 96 so that groove 96 receives the cross bar preferably including opposite sides 97, 99 of the bar. The shoe is rotated 102 toward cross bar 100 until resilient hook 110 is forced by bar 100 to move away from wall 112 side of groove 116, permitting entrance by bar 100 into groove 116 so that bar 100 is locked in groove 116 by hook 110 which resiles back over 178 bar 100.

In FIGS. 17-19, combined groove 116 and hook 110 bracket bar 100 so that the shoe is locked onto channel 58. Preferably combined groove 116 and hook 110 extend more than over the center of bar 100. However the hook need only extend over bar 100 sufficiently to prevent movement of groove 116 off bar 100 without external lifting force being applied.

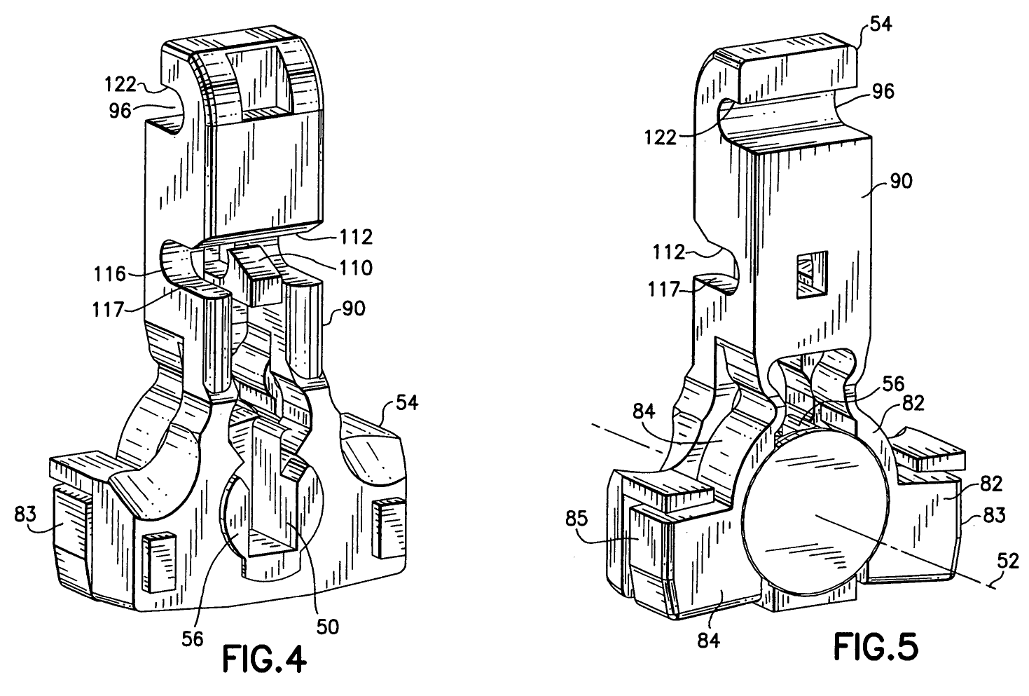

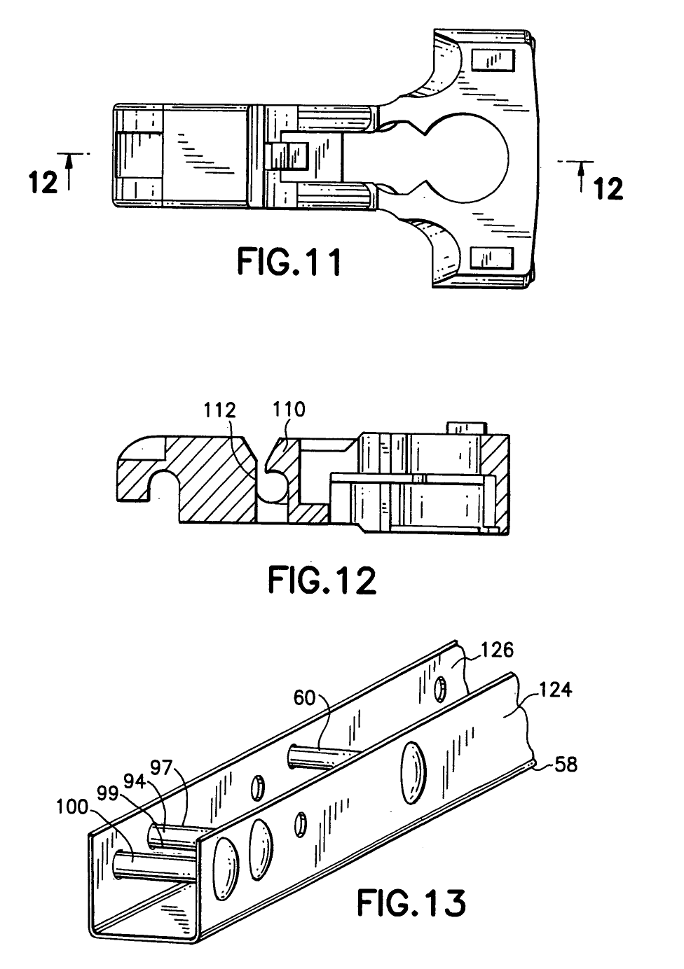

Referring to FIGS. 4, 11 and 12, resilient hook 110 is molded in one piece with housing 90, preferably allowing enough resilience so that the shoe can be rotated off bar 100, preferably by a person's fingers' pressure.

In FIGS. 13-15, cross bars 94 and 100 are fastened to opposite sides 124, 126 of channel 58. Preferably the bars extend into opposite sides 124, 126 and are preferably riveted 134 to the channel so that they cannot accidentally slide out of holes 128 in the sides of the channel.

Vertical counterbalance or lifting force exerted in the direction of the length 130 of the channel, transferred from channel 58 to shoe 54 can be received in compression by the shoe at wall 122 of groove 96 and in compression by the shoe at wall 112 of groove 116, from cross bars. Opposite force that may be exerted by bar 100 may cause hook 110 to move in the direction of wall 117, but wall 117 intercedes by receiving bar 100 before hook 110 is moved away from over bar 100. The vertical counterbalance force is received in compression by walls of the shoe in tandem in tandem grooves on the shoe.

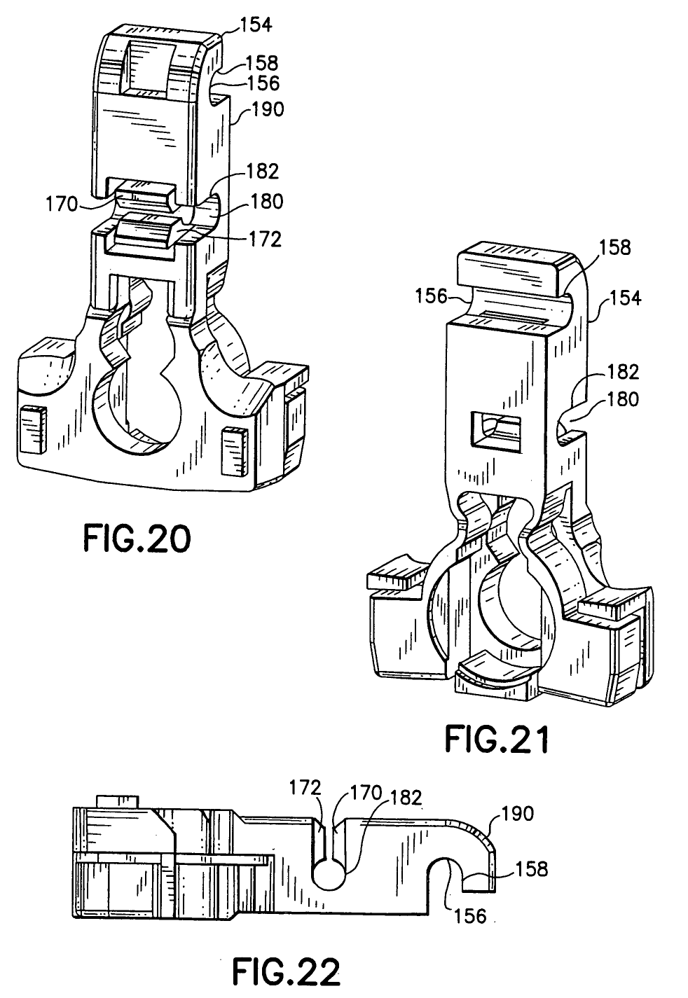

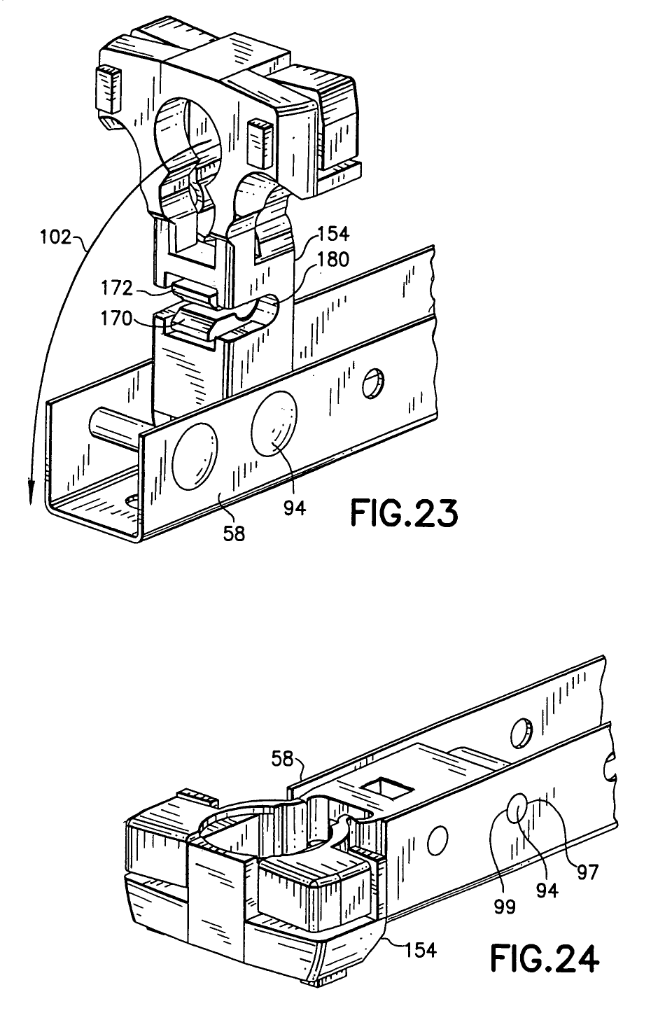

Referring to FIGS. 20-24, balance shoe 154 is mounted on U-shaped channel 58 by hooking the shoe pivotally under cross bar 94 by groove 156 so that groove 156 receives the cross bar preferably including opposite sides 97, 99 of the bar. The shoe is rotated 102 toward cross bar 100 until resilient hooks 170, 172 are forced apart by bar 100, permitting entrance by bar 100 into groove 180 so that bar 100 is locked in groove 180 by hooks 170, 172 which resile back over bar 100.

Resilient hooks 170, 172 are molded in one piece with housing 190.

Vertical counterbalance or lifting force exerted in the direction of the length 130 of the channel, transferred from channel 58 to shoe 154 can be received in compression by the shoe at wall 158 of groove 156 and in compression by the shoe at wall 182 of groove 180, from cross bars.

Although vertical lifting force exerted by bar 100 may cause hook 170 to move in the direction of wall 182, wall 182 receives the force, preventing hook 170 from moving away from over bar 100. The vertical counterbalance force is received in compression by walls of the shoe in tandem in tandem grooves on the shoe.

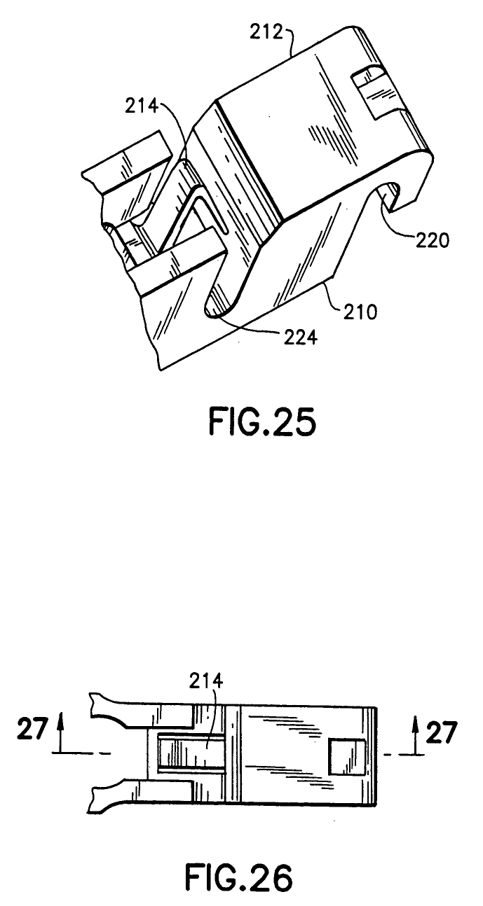

Referring to FIGS. 25-29, housing 210 of shoe 212 is molded one piece of plastic with resilient hook 214.

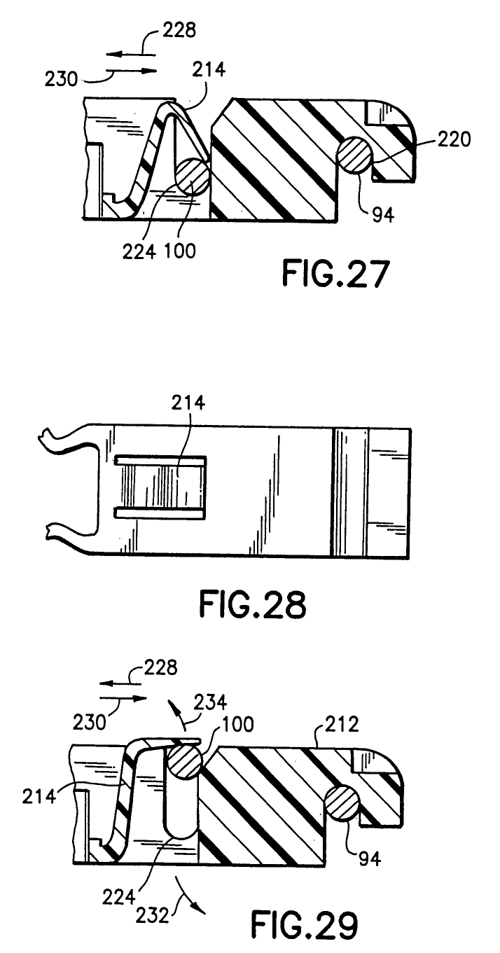

In FIG. 27, housing 210 is mounted on cross bars 94 and 100. Cross bar 94 is in groove 220. Cross bar 100 is locked in groove 224 by hook 214 which had resiled backward 228 and then forward 230 over the bar when the housing was rotated down onto bar 100.

In FIG. 29, as the housing is forcibly rotated off 232 cross bar 100, hook 214 flexes upward 234 and backward 228 so that cross bar 100 is released from groove 224. After bar 100 is removed from groove 224, the hook resiles back to its shape of FIG. 25.

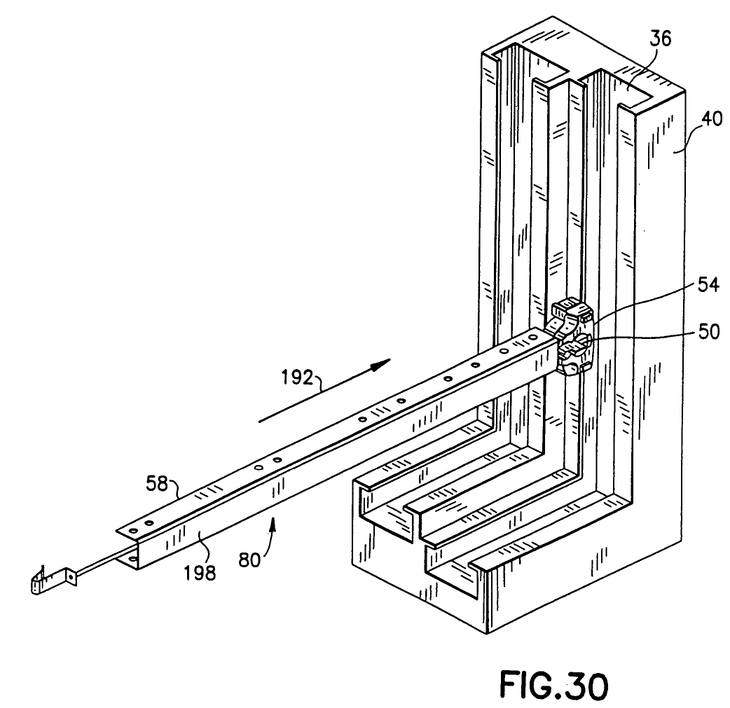

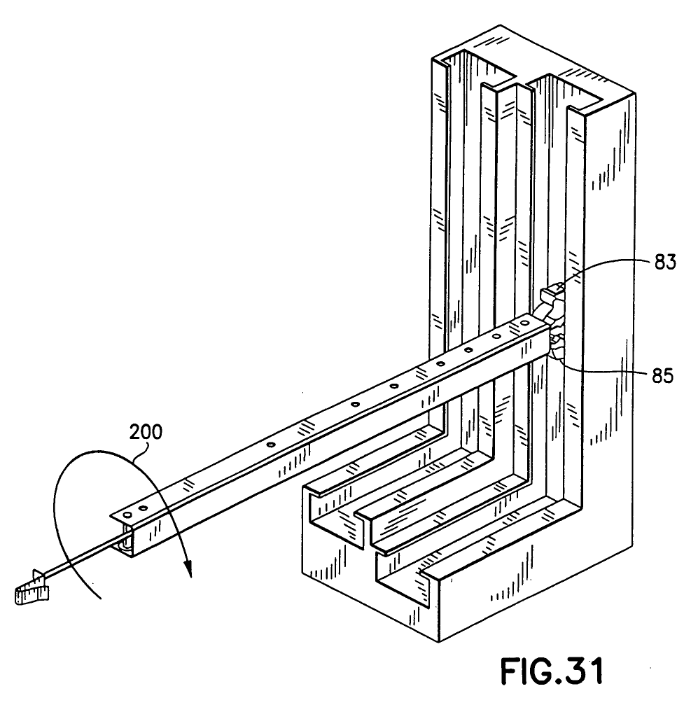

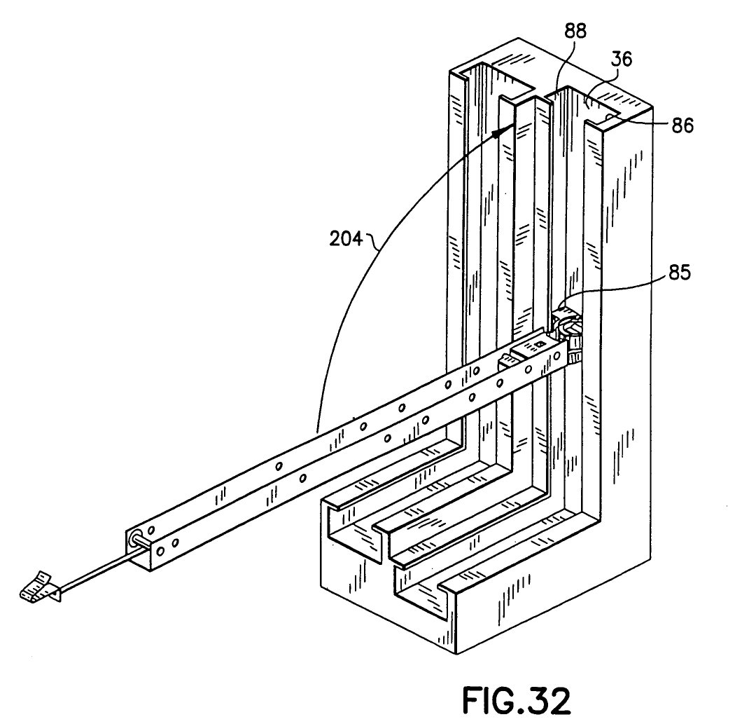

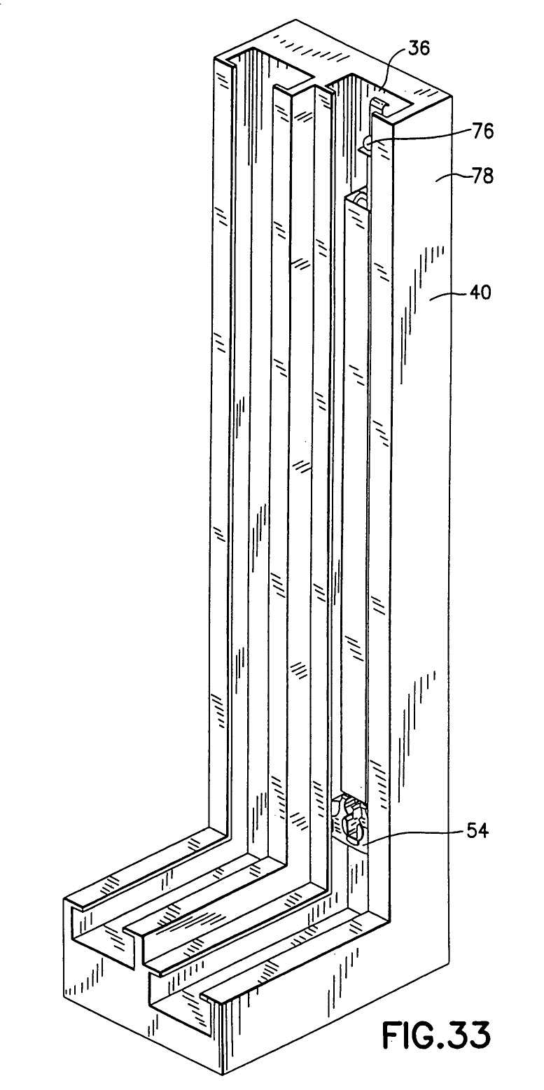

Referring to FIGS. 30-33, mounting of balance shoe assembly 80 on track 36 of window jamb 40 includes steps a-d of:
(a) holding U-shaped channel 58 horizontal generally perpendicular to track 36, insert 192 balance shoe 54 with slot 50 and the outside bottom 198 of the channel facing horizontally at nine-o'clock in end view.
(b) rotate 200 channel 58 clockwise in end view until channel 58 is open upward to twelve-o'clock and brake faces 83, 85 are facing sides 86, 88 of the track.
(c) flip or swing 204 channel 58 vertically until the channel is in track 36, parallel to the track.
(d) fasten attachment element 76 to window frame 78, preferably within the track.

Although the present invention has been described with respect to details of certain embodiments thereof, it is not intended that such details be limitations upon the scope of the invention. It will be obvious to those skilled in the art that various modifications and substitutions may be made without departing from the spirit and scope of the invention as set forth in the following claims.

1. A balance shoe for a window comprising a jamb and a sash adapted for rotating out of the jamb, comprising:
a frame having a length, a counterbalance apparatus mounted on the frame, a first bar extending transverse to the length mounted on said frame, and a second bar extending transverse to the length mounted on said frame spaced from said first bar,
a housing adapted for moving along the jamb, means on said housing responsive to rotation of the sash for engaging the jamb for preventing movement of said housing along the jamb when the sash is rotated out of the jamb when said housing is mounted on the jamb and connected to the sash, a first groove on said shoe shaped for receiving said first bar in a first direction, and a second groove on said shoe, spaced from said first groove and shaped for receiving said second bar in a second direction opposite to the first direction when said housing is mounted on said frame.

2. The balance shoe of claim 1 further comprising:
a resilient element extending from said housing across said second groove sufficiently so that said second bar is locked in said second groove by said resilient element when said housing is mounted on said frame with said second bar in said second groove.

3. A balance shoe for a window comprising a jamb and a sash adapted for rotating out of the jamb, comprising:
a frame having a length, means for elastically counterbalancing said frame when attached to a jamb, attached to said frame, a first bar extending transverse to the length mounted on said frame, and a second bar extending transverse to the length mounted on said frame spaced from said first bar,
a housing adapted for moving along the jamb, means on said housing responsive to rotation of the sash on a first axis for engaging the jamb for preventing movement of said housing along the jamb when the sash is rotated out of the jamb when said housing is mounted on the jamb and connected to the sash, a first groove on said shoe shaped for receiving said first bar in a first direction, and a second groove on said shoe, spaced from said first groove and shaped for receiving said second bar in a second direction opposite to the first direction when said housing is mounted on said frame.

4. The balance shoe of claim 3 further comprising:
a resilient element molded in one piece with said housing, extending across said second groove sufficiently so that said second bar is locked in said second groove by said resilient element when said housing is mounted on said frame with said second bar in said second groove.

5. The balance shoe of claim 4 wherein the first direction is generally parallel to the first axis when said housing is mounted on the jamb and connected to the sash.

6. The balance shoe of claim 4 wherein said second bar is fastened to said frame.

7. A balance shoe for a window comprising a jamb and a sash adapted for rotating out of the jamb, comprising:
a frame having a length, means for elastically counterbalancing said frame when attached to a jamb, attached to said frame, a first bar extending transverse to the length mounted on said frame,
a housing adapted for moving along the jamb, means on said housing responsive to rotation of the sash on a first axis for engaging the jamb for preventing movement of said housing along the jamb when the sash is rotated out of the jamb when said housing is mounted on the jamb and connected to the sash, a first groove on said shoe shaped for receiving said first bar in a first direction, a resilient element extending from said housing, extending across said first groove sufficiently so that said first bar is locked in said first groove by said resilient element when said housing is mounted on said frame with said first bar in said first groove.

8. The balance shoe of claim 7 wherein the first direction is generally parallel to the first axis when said housing is mounted on the jamb and connected to the sash.

9. The balance shoe of claim 7 wherein said first bar is fastened to said frame.

10. A balance shoe for a window comprising a jamb and a sash adapted for rotating out of the jamb, comprising:
a frame having a length, means for elastically counterbalancing said frame when attached to a jamb, attached to said frame, a first bar extending transverse to the length mounted on said frame,
a housing adapted for moving along said jamb, means on said housing responsive to rotation of the sash for engaging the jamb for preventing movement of said housing along the jamb when the sash is rotated out of the jamb when said housing is mounted on the jamb and connected to the sash, a first groove on said shoe shaped for receiving said first bar in a first direction, a pair of opposed resilient elements extending from said housing, bracketing said first groove so that said first bar is locked in said first groove by said pair of opposed resilient elements when said housing is mounted on said frame with said first bar in said first groove.

11. A balance shoe for a window comprising a jamb and a sash adapted for rotating out of the jamb, comprising:
a frame having a length,
a counterbalance comprising an elastic element having a first end attached to said frame against movement along said frame, and a second end attached to a first movable pulley block connected by a cord to a second pulley block attached to said frame against movement along said frame, for counterbalancing said frame when said cord is attached to a jamb,
a first bar extending transverse to the length of said frame mounted on said frame, and a second bar extending transverse to the length of said frame mounted on said frame spaced from said first bar,
a housing adapted for moving along said jamb, means on said housing responsive to rotation of the sash on a first axis for engaging the jamb for preventing movement of said housing along the jamb when the sash is rotated out of the jamb when said housing is mounted on the jamb and connected to the sash, a first groove on said shoe shaped for receiving said first bar in a first direction, and a second groove on said shoe, spaced from said first groove and shaped for receiving said second bar in a second direction opposite to the first direction when said housing is mounted on said frame,
a resilient element molded in one piece with said housing, extending across said second groove sufficiently so that said second bar is locked in said second groove by said resilient element when said housing is mounted on said frame with said second bar in said second groove.

12. The balance shoe of claim 11 wherein the first direction is generally parallel to the first axis when said housing is mounted on the jamb and connected to the sash.

13. A balance shoe for a window comprising a jamb and a sash adapted for rotating out of the jamb, comprising:
a frame having a length, U-shaped in cross section having a bottom and side walls, means for elastically counterbalancing said frame when attached to a jamb, attached to said frame, a first bar extending transverse to the length attached to a side wall of the U, and a second bar extending transverse to the length attached to a side wall of the U, spaced from said first bar,
a housing adapted for moving along the jamb, means on said housing responsive to rotation of the sash on a first axis for engaging the jamb for preventing movement of said housing along the jamb when the sash is rotated out of the jamb when said housing is mounted on the jamb and connected to the sash, a first groove on said shoe shaped for receiving said first bar in a first direction, and a second groove on said shoe, spaced from said first groove and shaped for receiving said second bar in a second direction opposite to the first direction when said housing is mounted on said frame.

14. The balance shoe of claim 13 further comprising:
a resilient element molded in one piece with said housing, extending across said second groove sufficiently so that said second bar is locked in said second groove by said resilient element when said housing is mounted on said frame with said second bar in said second groove.

15. The balance shoe of claim 14 wherein the first direction is generally parallel to the first axis when said housing is mounted on the jamb and connected to the sash.
